(19) United States
(12) Patent Application Publication
(10) Pub. No.: US 2006/0047793 A1
(43) Pub. Date: Mar. 2, 2006

(54) Method for configuring computing devices using reference groups

(75) Inventors: Dakshi Agrawal, Monsey, NY (US); Seraphin B. Calo, Cortlandt Manor, NY (US); James R. Giles, Evansville, IN (US); Kang-Won Lee, Nanuet, NY (US); Dinesh Verma, Mount Kisco, NY (US)

Correspondence Address: FERENCE & ASSOCIATES, 409 BROAD STREET, PITTSBURGH, PA, 15143, US

(73) Assignee: IBM Corporation, Armonk, NY (US)

(21) Appl. No.: 10/930,500

(22) Filed: Aug. 31, 2004

(51) Int. Cl. G06F 15/177

(52) U.S. Cl. 709/221

(57) ABSTRACT

Arrangements and methods for configuring at least one computing device using at least one reference group. In a preferred embodiment, a reference group of peer devices is identified, configuration settings of the peer devices are extracted, the extracted configuration settings are analyzed and at least one configuration template is provided. A recommended configuration template is then selected for the at least one computing device.

### FIELD OF THE INVENTION

The present invention relates generally to the field of the management of computing devices and more specifically to the configuration of computing devices.

### BACKGROUND OF THE INVENTION

One of the challenges of managing computing devices is to configure them properly. Large and medium size computing devices such as mail-servers, web-servers, and personal workstations have hundreds of parameters that need to be set. Smaller devices such as notebook computers, personal digital assistant, cell-phones have fewer parameters, however, owing to their mobility, they can have multiple profiles for specifying configuration based on their location. Examples are cell-phones with separate profile settings for office, home, car, etc. Each of the profiles requires tens of setting to be done by the user.

At present, the best solution to configure computing devices is to set reasonable defaults for configuration properties at the time of manufacture. Later, an administrator or a user customizes his/her computing devices by modifying these settings as required by their individual needs and environment. This process of changing factory settings of a device involves browsing through configuration parameters and changing default values to values more suitable for a particular pattern of usage, individual preference, or organizational requirements. The process of choosing more suitable values may involve looking at other instances of similar computing devices of self and colleagues, and comparing their configuration parameters to the factory-set parameters of the device, understanding the exact meaning and effect of the parameters, identifying their similarities and differences, and selecting an appropriate value for a configuration parameter if its default value is undesirable. This process requires skilled administrators or technically competent users. Furthermore, the process can tend to be inaccurate and error-prone.

Accordingly, a need has been recognized in connection with providing a novel solution that can be used to configure a computing device without requiring extensive browsing, learning details of the configuration settings and their implications, or manual configuration by a system expert, administrator, or user.

### SUMMARY OF THE INVENTION

There is broadly contemplated, in accordance with at least one presently preferred embodiment of the present invention, a canonical representation of configuration properties suitable for machine-assisted parsing and reasoning to distill templates derived from multiple configuration properties collected from a plurality of computing devices. Derived templates can be used by an administrator or a user to set the configuration of the target computing devices.

The comparison of different sets of configuration parameters by a skilled operator is not required. Instead, there is broadly contemplated the automatic configuration of target device settings by extracting common configuration parameters from the devices in the reference group. Alternatively, there can be recommended desired configuration settings so that the user can make an assisted (informed) decision about his/her device setting. Embodiments of the present invention are suitable both in an enterprise setting with large and medium scale installations, and in a context for individual users with personal computing devices.

In summary, one aspect of the invention provides an apparatus for configuring at least one computing device using at least one reference group, the apparatus comprising: an arrangement for identifying a reference group of peer devices; an arrangement for extracting configuration settings of the peer devices; an arrangement for analyzing extracted configuration settings; an arrangement for providing at least one configuration template; and an arrangement for selecting a recommended configuration template for the at least one computing device.

Another aspect of the invention provides a method for configuring at least one computing device using at least one reference group, the method comprising: identifying a reference group of peer devices; extracting configuration settings of the peer devices; analyzing extracted configuration settings; providing at least one configuration template; and selecting a recommended configuration template for the at least one computing device.

Furthermore, an additional aspect of the invention provides a program storage device readable by machine, tangibly embodying a program of instructions executable by the machine to perform method steps for configuring at least one computing device using at least one reference group, the method comprising: identifying a reference group of peer devices; extracting configuration settings of the peer devices; analyzing extracted configuration settings; providing configuration templates; and selecting a recommended configuration template for the at least one computing device.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 schematically illustrates a general method overview.

FIG. 2 schematically illustrates components in a first embodiment.

FIG. 3 schematically illustrates components in a second embodiment.

FIG. 4 schematically illustrates the operation of a configuration query module.

FIG. 5 schematically illustrates the operation of a configuration analyzer.

### DESCRIPTION OF THE PREFERRED EMBODIMENTS

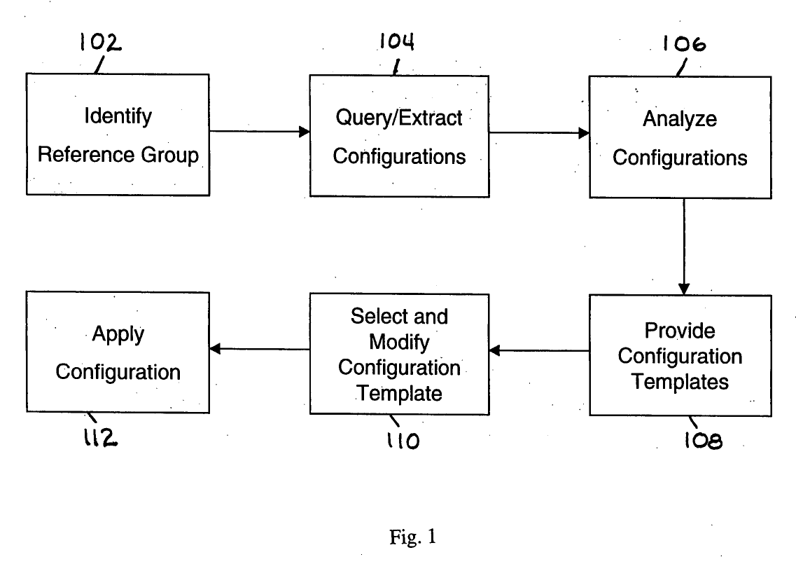

The overall flow of a general method overview, in accordance with at least one embodiment of the present invention, is shown in FIG. 1. In order to initially configure a computing device, a reference group of peer devices is identified (102). The reference group is either chosen by the user or the administrator, or in certain circumstances a reference group can be discovered and suggested by a discovery service that searches for a proper reference group based on the device type and/or the user's organization. For example, a systems expert designing a new mail-server image for a medium-size corporation may choose existing mail-servers in the same corporation as a reference group of peer devices. For an office cell-phone, a user may choose the reference group to be cell-phones of his or her office colleagues. Similarly, for a personal digital assistant (PDA), a user may choose the reference group to be the PDAs used by friends and families. In another case, a hospital or a car-rental company may impose a reference group decided by an expert panel or industry guidelines when personal devices such as tablet computers are used in hospitals or a global positioning system (GPS) device in a rented car. The reference group of devices may also be provided to a user or an administrator by a service that collects configuration settings from the personal devices that are similar to the target device. Such a service lets a user select his or her reference group by answering a series of simple yet carefully-designed questions or by selecting certain attributes of the users of the reference groups.

A goal of choosing the reference group is to make sure that the setting of personal device would be as close to the final configuration as a user would want, and would take different aspects (security requirements, privacy consciousness, personal preferences, organizational requirements, physical disabilities, etc.) of a user or a company into account. Note that the reference group of devices is not fixed and they need not be chosen all at once. The membership of reference group may be modified over time as more devices are added into or some of the devices are removed from the group.

Once the reference group is chosen, configuration settings of the peer devices in the reference group are preferably extracted (104). This can be done two ways: the peer devices themselves can be directly queried, or a database that stores the configuration settings of the peer devices can be queried. Devices in the reference group may be in the close vicinity of the target device and their configuration settings can be directly queried using various short-range communication protocols such as the Infrared Data Association (IrDA) protocol (the specifications of which are published by IrDa Special Interest Groups located on the Internet at www.irda.org) or Bluetooth protocol (the specifications of which are published by Bluetooth Special Interest Group located on the Internet at www.bluetooth.org) In another embodiment of the present invention, devices in the reference group may be connected via multi-hop network protocol such as the Internet Protocol (IP) (IETF RFC 791, September 1981, Internet Protocol, J Postel) and may be directly queried for their configuration information via standard system calls executed with proper authentication and authorization.

In other cases, the configuration data of peer computing devices is collected by an intermediary and is available in a well-known repository. The repository can be well-known in the sense that the access method and the connection point of the repository are defined in a standard manner so that any authorized entity can access it without explicit discovery mechanism. In such cases, configuration settings can be extracted from the database provided that the user has proper authentication and authorization. Examples of this case are when devices are being regularly backed up for disaster recovery, or when computing devices have an agent that periodically reports the configuration of the device to a central database so that compliance of the device with various security and privacy policies of an organization can be audited. In another case, a computer-service company may set up a best-practices database where its practitioners store configuration profiles of computing devices set in the field.

On the extracted configuration settings, a data-mining analysis is preferably performed (106) to find and then provide (108) configuration templates. Configuration templates contain the most frequently occurring features of configuration settings. More specifically, the features of configuration preferably include a set of configuration parameters without values specified. Note that configuration choices extend to certain rules that may have been configured in a device. For example, a PDA may be configured to download emails between certain hours of a day if it is connected to the Internet. A PDA may be configured to delete emails that do not come from users in the address book of the PDA etc. Once the most frequently occurring features have been extracted into configuration templates, a statistical analysis of configuration parameters in each of the features is preferably performed. Configuration templates populated with the values from statistical analysis are preferably used to provide recommendations for configuration setting of the target device.

The user or the administrator of the device, upon receiving the recommended template (provided at 108), can fill out parameters of the template based on an embedded statistical analysis (110). At this stage, they may also override any other parameters to customize the device. Either way, the resultant configuration is then preferably applied to the device (112). Furthermore, the user can choose to accept the best recommended template and apply the configuration setting without bothering to examine the configuration. In all cases, the user can modify the configuration settings at a later time if she finds some of the parameters to be inappropriate.

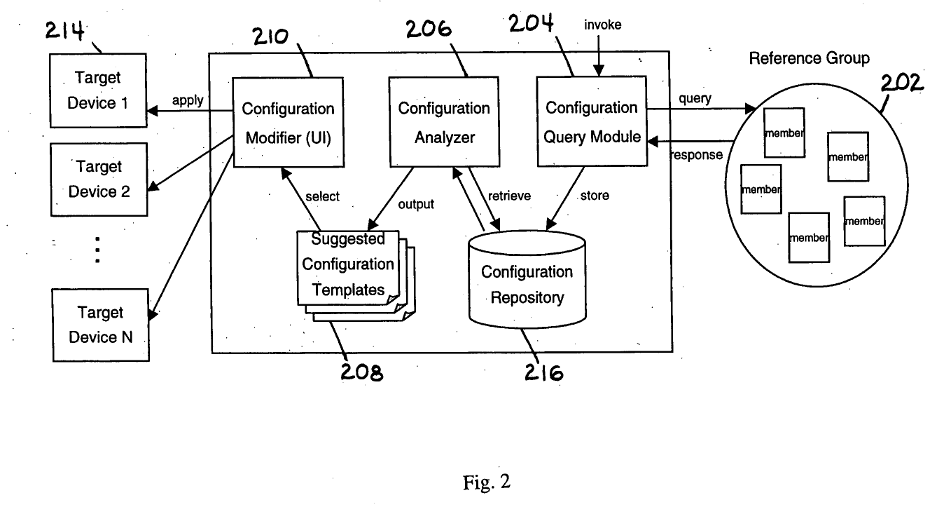

FIG. 2 shows an embodiment of the invention where a service is provided to the target device that wishes to receive a configuration recommendation. This embodiment can be used (but of course is not limited to such cases) when the target device has limited computing power, for example, cell phones, personal digital assistants. The user of such devices would provide answers to the configuration server for a few simple questions to indicate their preferences of reference group. The service in turn would query its database of configuration repository to extract the appropriate reference group, analyze configuration settings of the peer devices, and recommend a configuration for the target device.

Accordingly, a reference group 202 containing one or more members can be queried by query module 204. (“Invoke” in FIG. 2 represents a trigger of the sequence of action contemplated therein. Accordingly, after a reference group has been identified, for example, by asking some questions from the users, then the sequence of actions shown in FIG. 2 would be invoked.) In response, configuration settings of the peer devices in the reference group are preferably extracted and stored in repository 216. Configuration analyzer 206 preferably retrieves from repository 216 and thence outputs suggested configuration templates 208. Configuration modifier 210 serves to select and modify (as needed) configuration templates which are then applied to one or more target devices 1, . . . N (indicated at 214).

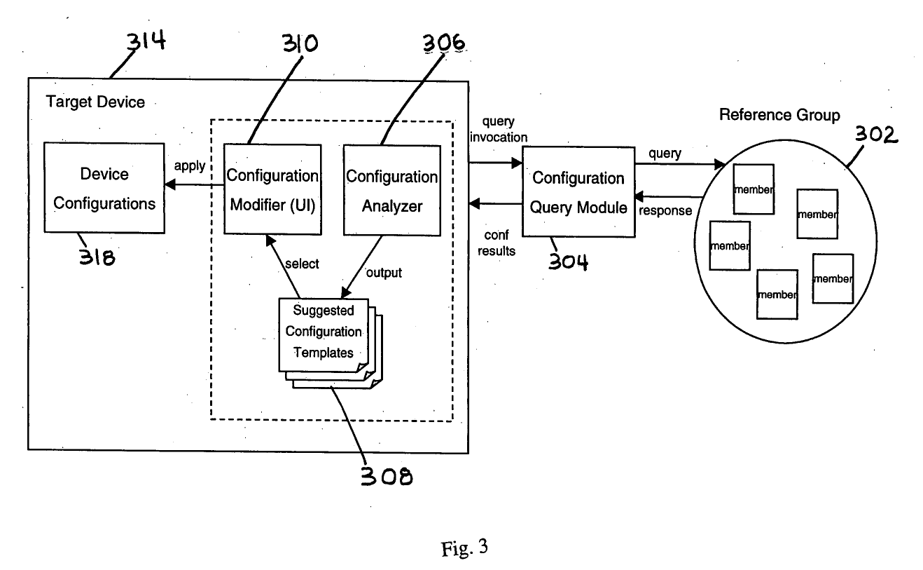

FIG. 3 shows an embodiment of the invention where inventive aspects are embedded within a target device 314. This embodiment can be used when a target device has sufficient computing power, for example, by various servers and desktop clients. In this scenario, when the target device 314 is initially set up, it queries preferably similar devices (reference group at 302) for their configuration settings via an intermediary configuration query module 304. Alternatively, the device can contact the reference group database for a configuration query. The target device 314 then preferably uses as discussed hereinabove to analyze (via analyzer 306) the configuration settings of peer devices and presents the recommended settings (308) to the user or the administrator doing the initial setup. The user or the administrator makes appropriate changes to the recommendations if required (at 310) and configures the target device via applying the ultimately desired configurations (318).

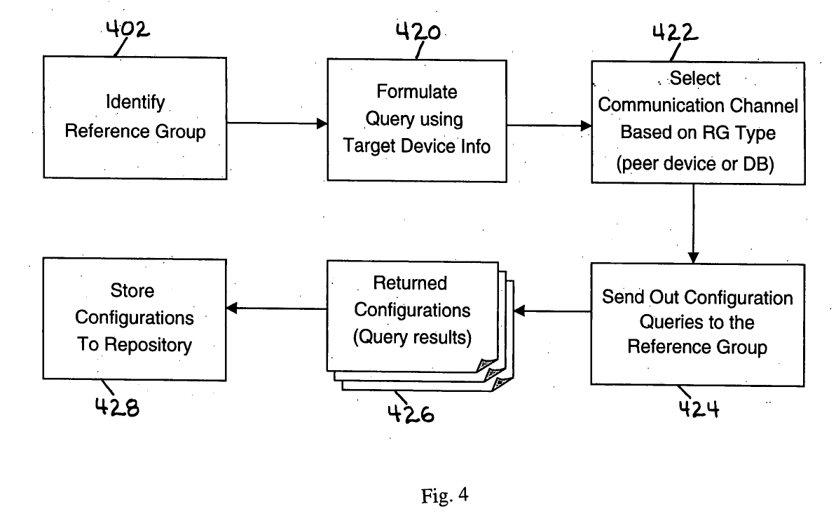

FIG. 4 shows a flowchart of the operation of a configuration query module, in accordance with an embodiment of the present invention. The module first preferably identifies a reference group of peer devices (402). This selection can be done on the basis of the preferences of the user of the target-device. The query module then formulates the query appropriate for the target device (420). Next, for the central repository or each peer device, it preferably selects a communication channel (422) and sends the configuration query (424). It preferably then collects the responses obtained from the repository or the peer devices (426) and stores them in the local configuration repository (428). The collected configurations in the local repository can be either stored in persistent data storage such as hard disk or in memory for smaller devices. These configurations are then preferably processed by a configuration analyzer module as touched upon heretofore.

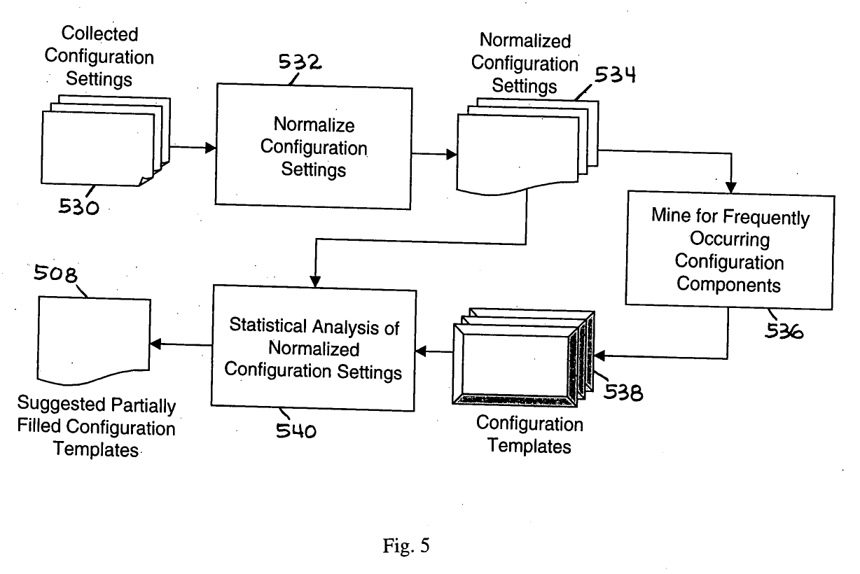

FIG. 5 shows a flowchart of the operation of a configuration analyzer, in accordance with an embodiment of the present invention. The input to the configuration analyzer is the collected configuration settings of peer devices in a reference group (530). Since peer devices may send its data in various different formats, the first step is to normalize the configuration settings into a canonical format (532). The normalization step also performs necessary processing such as sorting of the configuration parameters in particular order, and determining the minimum common denominator of the parameters. The normalized configuration settings (534) are then preferably data-mined for most frequently occurring configuration components (536), generating configuration templates (538). Configuration components include the setting of configuration parameters and rules. Configuration templates contain parameters whose values are unspecified. To guide the user for the values of these unspecified parameters, an analysis of the normalized configuration setting is performed (540). This analysis provides characteristics of unspecified parameters such as the most popular value of a parameter. The templates are partially filled with the characteristics of unspecified parameters to obtain suggested configuration settings for the target device (508).

In one embodiment of the present invention, by way of an illustrative and non-restrictive example, the data-mining step for frequently occurring configuration components can involve the following steps. Each configuration setting is normalized into a canonical form represented in eXtensible Markup Language (XML). The process of normalization takes certain equivalencies of expression into account and replaces equivalent expressions by their canonical form. This includes recognizing commutativity, associativity, and distributivity of various arithmetic and Boolean operators. For example, one needs to recognize that e1 op e2=e2 op e1, where e1 and e2 are arbitrary arithmetic or Boolean expression and op is an operator that has commutative property.

After the normalization, each configuration setting can be viewed as an expression tree, whose leaves represent data values and the internal nodes represent operators. Furthermore, the collection of normalized configuration settings can be viewed as an expression forest. Preferably, the most frequently occurring subtrees in this forest are then queried. These frequently occurring subtrees form configuration components that are composed together to make suggested configuration templates.

When candidate templates have been selected for the target device by the configuration analyzer, these templates get optionally reviewed by the user, who can select the most suitable template and modify the suggested parameters for further customization. Then the final configuration setting is translated into the data format that can be understood by the target device. This process is performed by the configuration modifier. When the target device requires configuration changes at a later time, the user can invoke the configuration modifier to perform this task. In a preferred embodiment of the configuration modifier will implement interactive graphical user interface so that user can easily browse the current setting and make simple changes.

It is to be understood that the present invention, in accordance with at least one presently preferred embodiment, includes an arrangement for identifying a reference group of peer devices, an arrangement for extracting configuration settings of the peer devices, an arrangement for analyzing extracted configuration settings, an arrangement for providing at least one configuration template, and an arrangement for selecting a recommended configuration template for the at least one computing device. Together, these elements may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An apparatus for configuring at least one computing device using at least one reference group, said apparatus comprising:
an arrangement for identifying a reference group of peer devices;
an arrangement for extracting configuration settings of the peer devices;
an arrangement for analyzing extracted configuration settings;
an arrangement for providing at least one configuration template; and
an arrangement for selecting a recommended configuration template for the at least one computing device.

2. The apparatus according to claim 1, further comprising; and
an arrangement for applying a selected recommended configuration template to the at least one computing device.

3. The apparatus according to claim 1, wherein said arrangement for extracting configuration settings is adapted to query the peer devices directly.

4. The apparatus according to claim 1, wherein said arrangement for extracting configuration settings is adapted to query a database which stores configuration settings.

5. The apparatus according to claim 1, wherein said arrangement for analyzing extracted configuration settings is adapted to analyze extracted configuration settings via data mining.

6. The apparatus according to claim 1, wherein:
the at least one configuration template contains the most frequently occurring features of configuration settings; and
said arrangement for providing at least one configuration template is adapted to extract one or more most frequently occurring features of configuration settings into at least one configuration template.

7. The apparatus according to claim 6, wherein said arrangement for providing at least one configuration template is adapted to perform an analysis of parameters in the one or more most frequently occurring features.

8. The apparatus according to claim 7, wherein said arrangement for selecting a recommended configuration template is adapted to provide at least one recommendation relating to configuration setting of the at least one computing device based on values from the analysis.

9. The apparatus according to claim 1, wherein said apparatus is external to the at least one computing device.

10. The apparatus according to claim 1, wherein at least a portion of said apparatus is substantially internal to the at least one computing device.

11. A method for configuring at least one computing device using at least one reference group, said method comprising:
identifying a reference group of peer devices;
extracting configuration settings of the peer devices;
analyzing extracted configuration settings;
providing at least one configuration template; and
selecting a recommended configuration template for the at least one computing device.

12. The method according to claim 11, further comprising the step of applying a selected recommended configuration template to the at least one computing device.

13. The method according to claim 11, wherein said step of extracting configuration settings comprises querying the peer devices directly.

14. The method according to claim 11, wherein said step of extracting configuration settings comprises querying a database which stores configuration settings.

15. The method according to claim 11, wherein said step of analyzing extracted configuration settings comprises analyzing extracted configuration settings via data mining.

16. The method according to claim 11, wherein:
the at least one configuration template contains the most frequently occurring features of configuration settings; and
said step of providing at least one configuration template comprises extracting one or more most frequently occurring features of configuration settings into at least one configuration template.

17. The method according to claim 15, wherein said step of providing at least one configuration template comprises performing an analysis of parameters in the one or more most frequently occurring features.

18. The method according to claim 16, wherein said step of selecting a recommended configuration template comprises providing at least one recommendation relating to configuration setting of the at least one computing device based on values from the analysis.

19. The method according to claim 11, wherein said method is performed substantially externally with respect to the at least one computing device.

20. The method according to claim 11, wherein at least a portion of said method is performed substantially internally with respect to the at least one computing device.

21. A program storage device readable by machine, tangibly embodying a program of instructions executable by the machine to perform method steps for configuring at least one computing device using at least one reference group, said method comprising:
identifying a reference group of peer devices;
extracting configuration settings of the peer devices;
analyzing extracted configuration settings;
providing configuration templates; and
selecting a recommended configuration template for the at least one computing device.
